(19) United States
(12) Patent Application Publication
(10) Pub. No.: US 2023/0196382 A1
(43) Pub. Date: Jun. 22, 2023

(54) Photocopy or Counterfeit Detection in Symbologies

(71) Applicant: Sys-Tech Solutions, Inc., Princeton, NJ (US)

(72) Inventors: Bodhayan Dev, Sturbridge, MA (US); Michael Soborski, Allentown, NJ (US); Atish P. Kamble, Acton, MA (US); Prem Swaroop, Lexington, MA (US)

(21) Appl. No.: 17/692,064

(22) Filed: Mar. 10, 2022

Related U.S. Application Data
(60) Provisional application No. 63/292,706, filed on Dec. 22, 2021.

(51) Int. Cl. G06Q 30/00; H04L 9/32; G06K 19/06; G06T 7/40; G06N 5/00

(52) U.S. Cl. CPC G06Q 30/0185; H04L 9/3247; G06K 19/06009; G06T 7/40; G06N 5/003

(57) ABSTRACT

Methods, systems, and apparatus, including medium-encoded computer program products, for photocopy or counterfeit detection include: obtaining images with a representation of a same mark and predicting an authenticity of the representation of the same mark in each image to obtain an authenticity prediction corresponding to each image of the set of images. The authenticity predictions are consolidated to determine an ensemble prediction of authenticity associated with the same mark.

### CROSS REFERENCE TO RELATED APPLICATIONS

This application claims priority to U.S. Provisional Application No. 63/292,706, filed Dec. 22, 2021, the entire contents of each of which are incorporated herein by reference.

### BACKGROUND

Marks are applied to a good to uniquely identify the good. A mark is a symbol that encodes information in accordance with a predefined symbology. Counterfeit goods are widely available and often hard to spot. When counterfeiters produce fake goods they typically copy the associated symbology including a mark, in addition to the actual goods. To the human eye, a photocopy or counterfeit mark can is appear genuine and even yield the appropriate message (e.g., decode to the appropriate message associated with the symbology). Many of the technologies currently available to counter such copying rely on visually comparing an image of a possible counterfeit mark with an image of an original, genuine mark.

### SUMMARY

An embodiment described herein provides a method that enables photocopy or counterfeit detection in symbologies. The method includes obtaining images with a representation of a same mark and predicting an authenticity of the representation of the same mark in each image to obtain an authenticity prediction corresponding to each image of the set of images. The method also includes consolidating the authenticity predictions to determine an ensemble prediction of authenticity associated with the same mark.

An embodiment described herein provides a system that enables photocopy or counterfeit detection in symbologies. The system includes at least one processor and at least one non-transitory storage media storing instructions that, when executed by the at least one processor, cause the at least one processor to obtain images with a representation of a same mark and predict an authenticity of the representation of the same mark in each image to obtain an authenticity prediction corresponding to each image of the set of images. The instructions also case the at least one processor to consolidate the authenticity predictions to determine an ensemble prediction of authenticity associated with the same mark.

An embodiment described herein provides at least one non-transitory storage media storing instructions that, when executed by at least one processor, cause the at least one processor to obtain images with a representation of a same mark and predict an authenticity of the representation of the same mark in each image to obtain an authenticity prediction corresponding to each image of the set of images. The instructions also cause the at least one processor to consolidate the authenticity predictions to determine an ensemble prediction of authenticity associated with the same mark.

### BRIEF DESCRIPTION OF DRAWINGS

FIG. 1 shows examples of symbologies.

FIG. 2 is a block diagram of a workflow for photocopy or counterfeit is detection in symbologies.

FIG. 3 is a block diagram of a texture feature based machine learning model.

FIG. 4 is a block diagram of a gray level co-occurrence matrix (GLCM) feature based machine learning model.

FIG. 5 is a block diagram of a pre-trained deep learning model.

FIG. 6 is a block diagram of a pre-trained lite deep learning model.

FIG. 7 shows a process for photocopy or counterfeit detection in symbologies.

FIG. 8 is a block diagram of a system that enables photocopy or counterfeit detection in symbologies.

### DETAILED DESCRIPTION

Marks are used to convey information or data (e.g., a message) associated with goods, and are applied to the goods or packaging of the goods. Marks can be referred to as an “original item identifier” and include quick response (QR) codes and barcodes. In some cases, marks are generated using a thermal transfer or ink-jet process to create highly uniform, solid, black or other printed areas using a predetermined format. The precise printing used to generate marks can produce marks that are not easily replicated. Processes used to replicate a mark tend to produce printed areas in which the black areas are grayer at low resolutions and mottled at high resolutions when compared to a genuine mark. The present systems and techniques enable photocopy or counterfeit detection in symbologies. Subtle differences in marks are detected and evaluated to predict if the mark is a genuine mark.

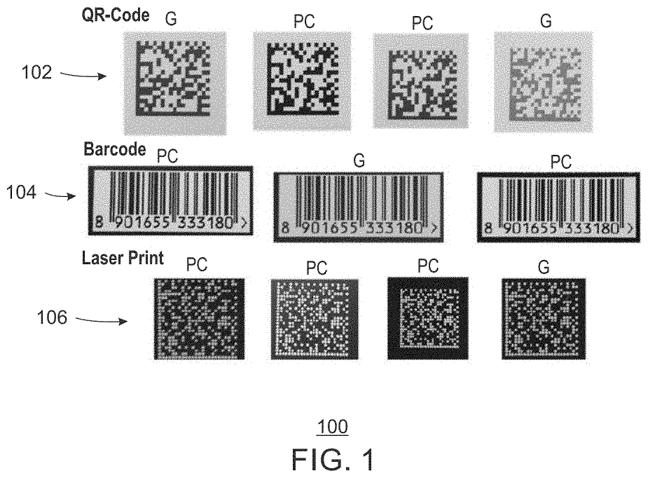

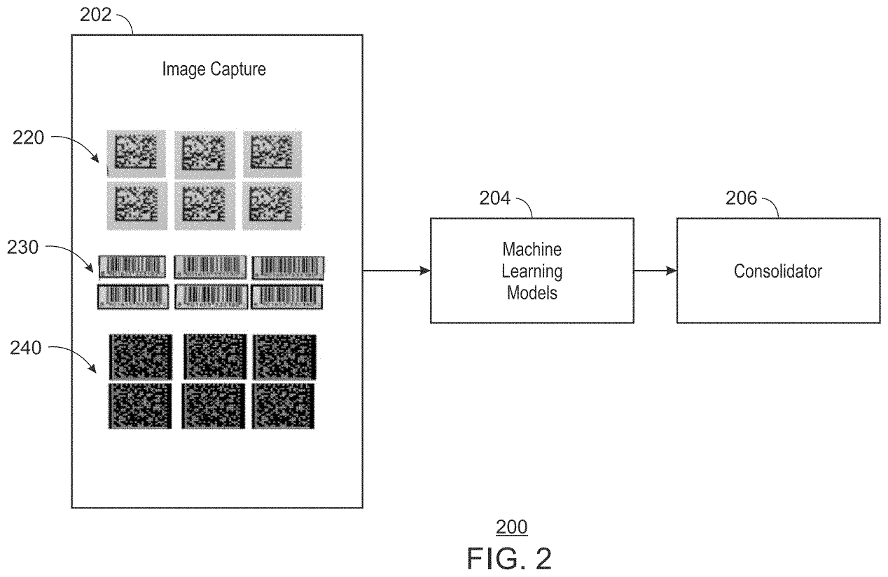

FIG. 1 is shows examples of symbologies 100. Generally, a mark is a symbol that encodes information in accordance with a predefined symbology. The marks can be visible or invisible to the human eye, such as marks with inks that invisible until they fluoresce under UV light. In FIG. 1, several marks are illustrated, each with genuine (“G”) marks and marks that are photocopies (“PC”) of genuine marks. The present techniques use machine learning models to determine the natural variations inherent in many manufacturing, marking, or printing processes to predict an authenticity of a mark. Authenticity of a mark refers to a classification of genuine or photocopy/counterfeit associated with the mark. The predicted classifications according to the present techniques integrate into existing reader systems for applied marks, such as bar code readers or machine vision systems; no specialized systems are needed to perceive variations in photocopy/counterfeit marks when compared to genuine marks. In examples, a set of metrics associated with a characteristic of a genuine mark are measured. An electronic signature is generated based on the set of metrics for the genuine mark, wherein the electronic signature is generated in parallel with consolidating (e.g., consolidator 206 of FIG. 2) the authenticity predictions to determine the ensemble prediction of authenticity associated with the same mark.

In the example of FIG. 1, the symbologies include a quick response (QR) code 102, barcode 104, and a mark generated by laser print 106. Generally, a QR-code 102 is a machine-readable, two-dimensional matrix-type barcode. The QR-code visually consists of black squares arranged in a square grid on a white background. The QR-code is captured by an image capture device such as a camera, and is processed using error correction to extract information contained in the QR-code. In particular, data is extracted from patterns that are present in both horizontal and vertical components of the mark. Similarly, the barcode 104 is a machine-readable, one-dimensional linear-type barcode. Similar to a QR-code, a barcode is captured by an image capture device such as a camera, and is processed to extract data contained in the barcode. The laser print 106 is created by non-contact printing, such as laser or thermal printing. The laser printing marks engrave high quality one dimensional (1D) or two dimensional (2D) barcodes or QR-codes, multiple lines of text, batch numbers, lot codes, logos, and the like on goods.

Generally, symbologies such as the QR-codes 102, barcodes 104, and laser print 106 are captured by an image capture device such as a scanner or camera, and are processed to extract information contained in the mark. The image capture device detects an intensity of light reflected by spaces in the pattern created by the mark. In some embodiments, an illumination system outputs infrared light that is reflected by portions of the mark, and the image capture device captures reflected infrared light.

For ease of description, particular symbologies are described. However, the symbologies may include any suitable mark. In some cases, the mark that represents data in a visual, machine-readable form. In examples, the symbology is continuous or discrete. In examples, a continuous symbology is one in which the entire symbology is read at once. Portions of a continuous symbology are invalid. By contrast, a discrete is symbology is a symbology with multiple independent portions. The symbology may be two-width or many width, with several bars or spaces that are multiples of a basic width. In some cases, the symbology includes interleaving. In interleaving, a first character is encoded using black bars of varying width and the second character is then encoded by varying the width of the white spaces between black bars of the first character. Characters are encoded in pairs over the same section of the barcode. The present techniques detect photocopy/counterfeit marks that may be otherwise undetectable. Detecting photocopy/counterfeit marks enables an increased confidence in symbologies as representing genuine, authentic goods. The identification of photocopy/counterfeit marks can be used to eliminate the sale of unauthorized goods. In this manner, accurate photocopy/counterfeit detection according to the present techniques positively impacts a customer trust in a brand as well as brand value.

FIG. 2 is a block diagram of a workflow for photocopy or counterfeit detection in symbologies. The symbologies can include, for example, any symbology 100 described with respect to FIG. 1. As discussed above, the symbology includes a visual representation of a mark that is that is processed to extract information.

Generally, a photocopy is a mark that results from copying a genuine mark that represents goods and/or services. A photocopy is not a genuine mark. The photocopy is presented as a genuine representation of a mark and is intended to contain the same information as the mark from which the photocopy is generated. Copying techniques and devices, such as photocopiers, are able to emulate a genuine mark of a symbology with a high accuracy. In examples, the high accuracy refers to a photocopy that is undetectable by the human eye. Generally, a counterfeit mark refers to a mark that is intentionally created to deceive or mislead while being associated with information and/or representing goods of an authentic mark. A counterfeit mark is not a genuine mark. The counterfeit mark is presented as a genuine representation of a mark.

In the workflow 200, image capture 202 is used to obtain multiple image pairs of a mark. Obtaining image pairs includes receiving the images from another source and capturing the images using an image capture device. The another source can be a local or remote database with stored images. In the example of FIG. 2, symbologies including a QR-code, barcode, and laser print are illustrated. Image pairs 220 include a QR-code, image pairs 230 include a barcode, and image pairs 240 is include laser print. One or more machine learning models 204 are trained using multiple symbologies, including but not limited to QR-codes, barcodes, and laser print.

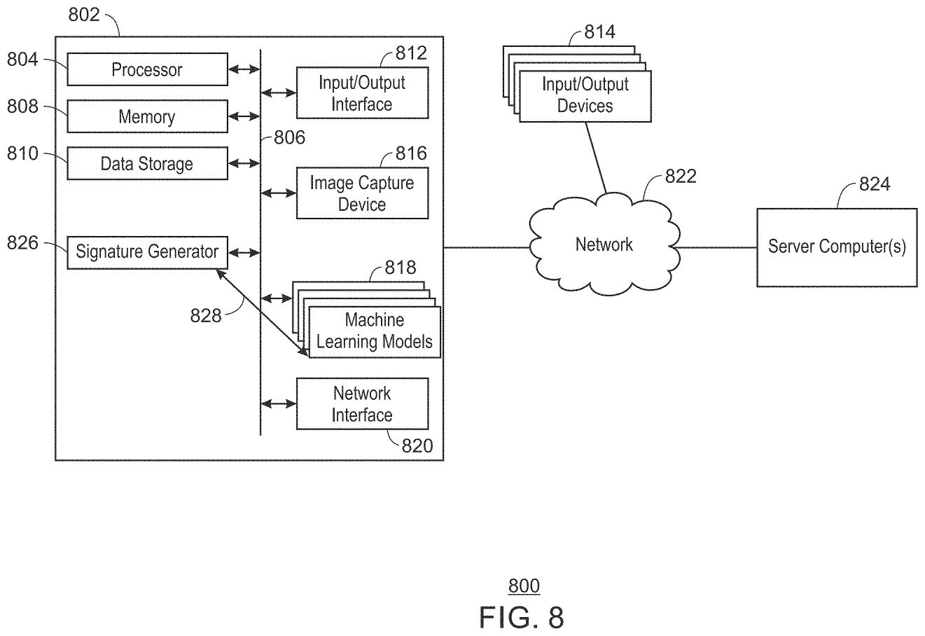

In operation, two or more images of the mark are captured, generating images that contain a representation of the same mark. In some embodiments, the images are high resolution images. The resolution can vary. In some examples, a high resolution image is an image that has a resolution of greater than 96 dots per inch (dpi). A cell phone, camera, scanner, or other device (e.g., controller 802 of FIG. 8) can be used to capture the images containing a representation of the same mark. In some examples, the images include a substantially similar pose of the same mark. The pose of the mark refers to a position and orientation of the mark in a given image. In some examples, an image of the multiple images includes the same mark at a different pose.

For example, a person uses a device to capture multiple images of the mark. During the course of image capture, poses of the mark vary. In some cases, the variation in poses among images is minimal, such that the mark is at a substantially similar pose in the multiple images. This can occur, for example, when the images are taken in a short period of time (e.g., less than a couple of seconds) or as the result of a burst mode that automatically captures multiple images in rapid succession. In some cases, the variation in poses creates at least one image with the same mark in a different pose when compared to the multiple images. This can occur, for example, when the images are taken over a longer period of time (e.g., more than a couple of seconds). In some cases, the multiple images vary in quality. For example, the multiple images can have varying levels of focus/blurriness, illumination, percentage of the mark contained within the image capture device field of view, or any combinations thereof.

Multiple images containing a representation of a mark are provided as input to a trained machine learning model 204, and the trained machine learning model 204 makes a prediction of genuine or photocopy/counterfeit for each image of the multiple images. A consolidator 206 consolidates the prediction of genuine or photocopy/counterfeit for each image of the multiple images and outputs a prediction of authenticity for the mark. A mode of predictions associated with the multiple images is used to consolidate the machine learning model results for the multiple images. The mode refers to statistical voting. In examples, if an equal number of is images are predicted as genuine or photocopy/counterfeit, then the mark is predicted to be a photocopy/counterfeit. For example, when six images of a mark are obtained at image capture 202 and provided as input to a trained machine learning model 204, predictions for each image are consolidated by determining a mode or statistical voting associated with the predictions. In this example, if the trained machine learning model outputs a prediction for three images of photocopy/counterfeit and a prediction for the three remaining images of genuine, the consolidator labels the mark contained in the images as a photocopy/counterfeit.

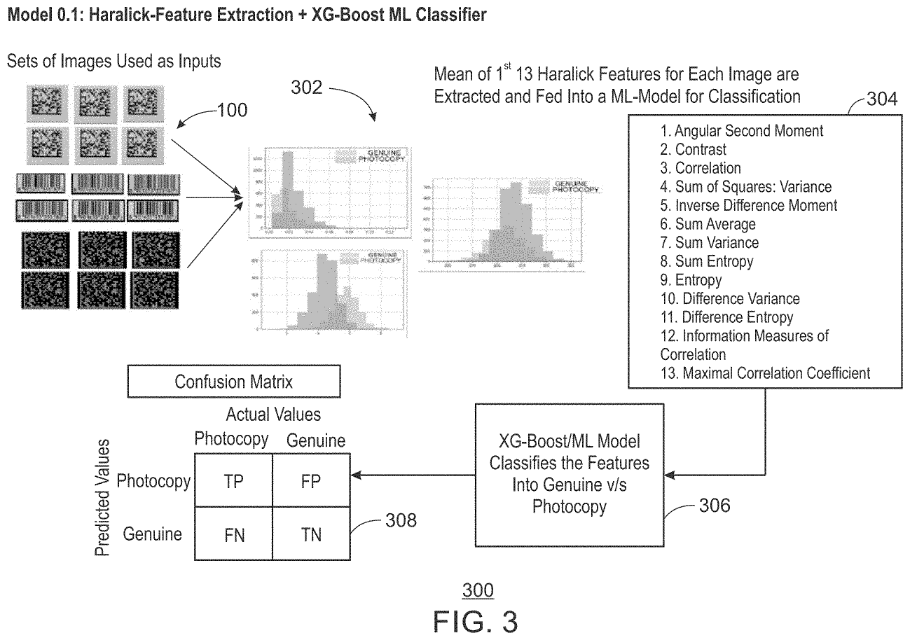

In examples, the present techniques enable high-resolution image capture of six images containing a representation of at least a portion of the same mark. For each image, the prediction of genuine or photocopy/counterfeit is realized using one or more machine learning models 204. The various machine learning models are further described with respect to FIGS. 3-6. Table 1 is a description of the various model types illustrated in FIGS. 3-6, with associated details and potential deployment environments. Although particular deployment environments are described with respect to each model, the deployment environments can vary. For example, the models 300, 400, and 500 can be deployed using an edge/mobile device, although they are listed in Table 1 as cloud based.

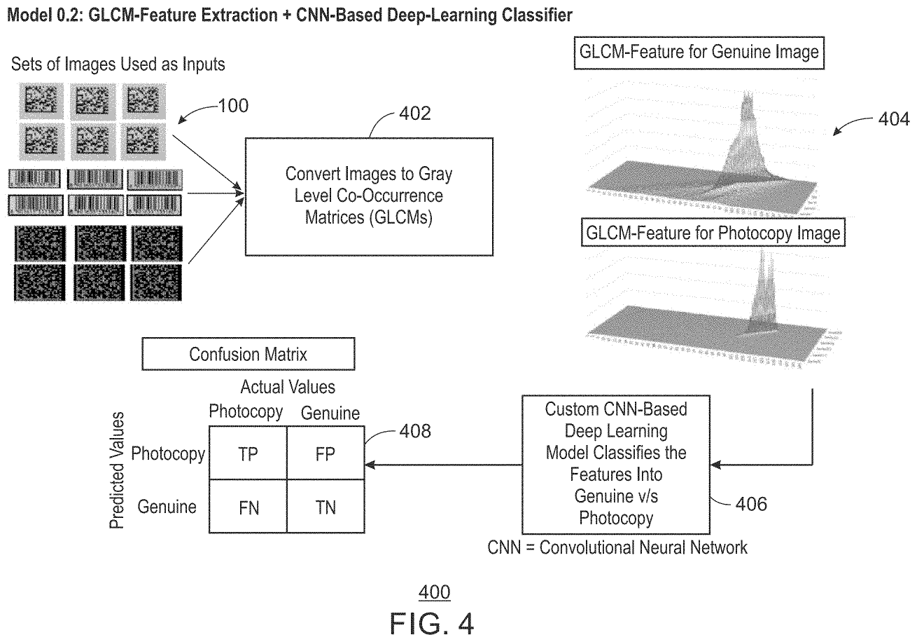

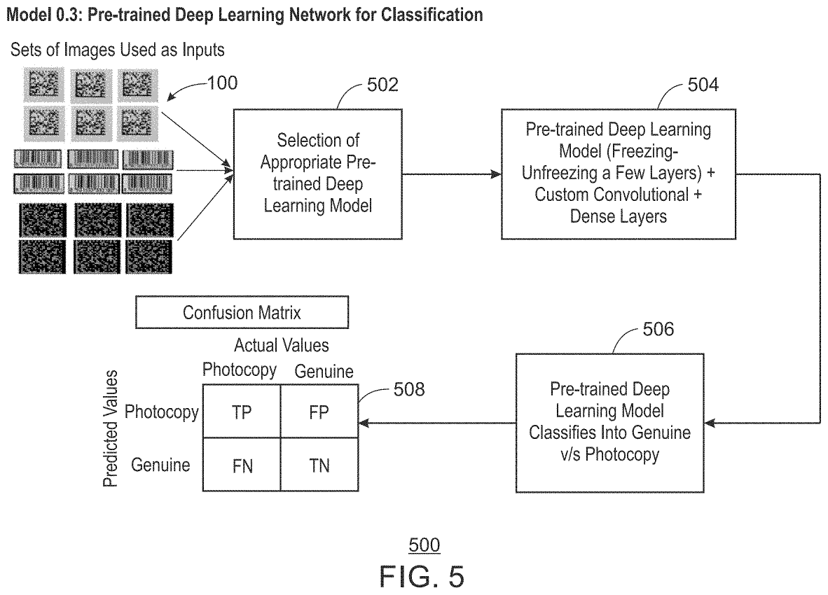

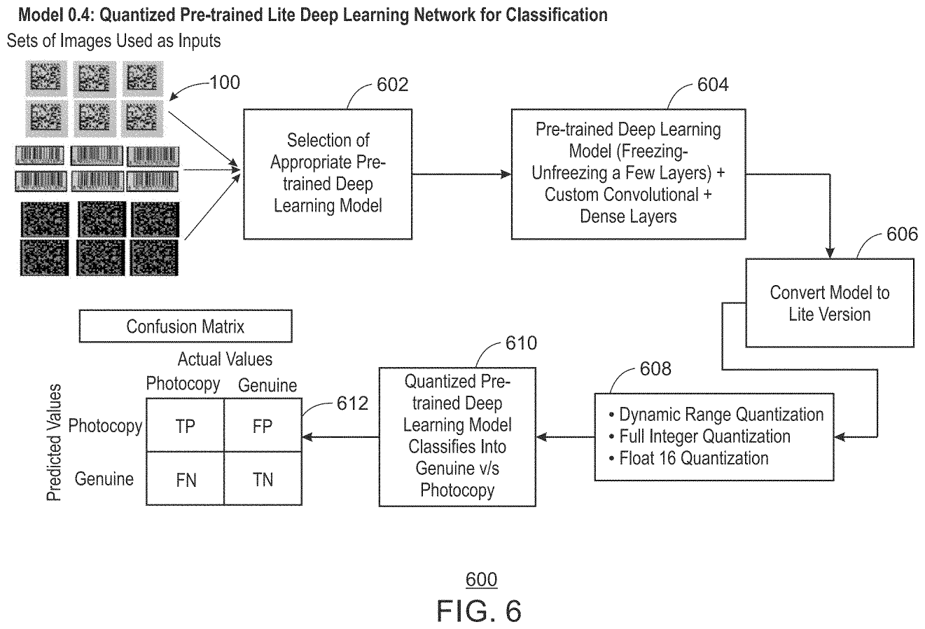

TABLE 1

| | | Deployment |
|---|---|---|
| Model types | Model Details | Enviroment |
| Computer-vision | FIG. 3:. Haralick Features | Cloud |
| and ML-Model | extraction + XG-boost/ML model | |
| Computer-Vision | FIG. 4: GLCM-Feature | Cloud; |
| and DL-Model | extraction + Custom | Edge/Mobile |
| | Convolutional Neural Network | |
| DL-Model | FIG. 5: Pre-trained DL | Cloud; |
| | Architectures | Edge/Mobile |
| DL-Lite Model | FIG. 6: Quantized Pre-trained | Edge/Mobile |
| | Model- Lite Architectures | |

FIG. 3 is a block diagram of a texture feature based machine learning model 300. In examples, the model 300 infrastructure is feasible for cloud-deployment. Image pairs are obtained as input to a transformation at block 302 to create one or more gray-level coocurrence matricies. Generally, texture features are defined by higher-order statistics used for texture analysis. In the example of FIG. 3, the texture features are Haralick features. The Haralick features are extracted and provided as input to a gradient boosted decision tree classifier, such as an XG-Boost machine learning model. In embodiments, the Haralick features are extracted and provided as input to a support vector machines (SVM) or random forest algorithms.

The basis for Haralick features is a gray-level co-occurrence matrix (GLCM) G [N_{g}, N_{g}]. This matrix is square with dimension N_{g}, where N_{g} is the number of gray levels in the image. Element [i,j] of the matrix is generated by counting the number of times a pixel with value i is adjacent to a pixel with value j and then is dividing the entire matrix by the total number of such comparisons made. Each entry is therefore considered to be the probability that a pixel with value i will be found adjacent to a pixel of value j. Accordingly, the GLCM of an image is defined as follows:

$$G = [ \begin{matrix}P ( 1 , 1 ) & … & P ( 1 , Ng ) \\ ⋮ & ⋱ & ⋮ \\ P ( Ng , 1 ) & … & P ( Ng , Ng )\end{matrix} ]$$

At block 304, predefined feature types are illustrated. The Haralick features include the following predefined features, which are computed using the GLCM for each image: 1) Angular Second Moment; 2) Contrast; 3) Correlation; 4) Sum of Squares: Variance; 5) Inverse Difference Moment; 6) Sum Average; 7) Sum Variance; 8) Sum Entropy; 9) Entropy; 10) Difference Variance; 11) Difference Entropy; 12) Information Measures of Correlation; 13) Maximal Correlation Coefficient. Although predefined features are provided herein, other features are available through statistical analysis of the GLCM.

Generally, a texture feature is determined by analyzing a spatial distribution of gray values in an image by computing local features at each point in the image and inferring a set of statistics from the distributions of the local features using the GLCM. The distribution of gray values for each feature is different for photocopy/counterfeit mark when compared to a genuine image. At block 306, the extracted features are input into a classification algorithm (e.g., machine learning classifiers such as XG-Boost, Random Forest, or SVM ML based algorithm) to predict a classification of the images as genuine or photocopy/counterfeit. The prediction from the multiple images are used to consolidate a prediction for the captured mark.

At block 308, a confusion matrix is illustrated. The confusion matrix is used to evaluate the effectiveness of the trained classifier at block 306. Machine learning statistical measures are implemented to determine error based uncertainties. Machine learning statistical measures include, but are not limited to, false positive (FP), false negative (FN), true positive (TP), and true negative (TN) probabillities. Generally, the machine learning statistical measures are based on a ground truth compared with a prediction output by a trained classifier. In evaluating the machine learning statistical measures, a false positive is an error that indicates a condition exists when it actually does not exist. A false negative is an error that incorrectly indicates that a condition does not exist. A true positive is a correctly indicated positive condition, and a true negative is a correctly indicated negative condition. For evaluation of a trained classifier, the actual category of each image is known. By evaluating the performance of the classifier with known data in terms of FP, FN, TP, and TN, the trained classifier can be iteratively updated to provide optimal performance with input images.

FIG. 4 is a block diagram of a gray level co-occurrence matrix (GLCM) feature based machine learning model 400. In examples, the model 400 infrastructure is feasible for cloud-deployment. Image pairs are obtained as input to a transformation at block 402. In the example of FIG. 4, each image is transformed into GLCM matrix. Photocopiers are generally unable to replicate the color or background information of a mark with high precision (e.g., undetectable by matrix transformation), and the GLCM transformation for each image enables detection of variations in gray-levels and background information. In some embodiments, a classifier is trained using variations in gray-levels and background information between genuine and photocopy/counterfeit marks. For training, at block 404, GLCM features are extracted for each of a genuine image and a photocopy/counterfeit image. The GLCM features are input to a convolutional neural network (CNN) at block 406. In some embodiments, the CNN at block 406 is a custom CNN-based deep learning model that is trained to predict a classification of genuine or photocopy/counterfeit for an input image. Predictions for multiple images are used to generate an ensemble prediction for the captured mark. A confusion matrix at block 408 is used to evaluate the effectiveness of the trained classifier at block 406. For evaluation of a trained classifier, the actual category of each image is known. By evaluating the performance of the classifier with known data, the trained classifier can be iteratively updated to provide optimal performance with input images.

FIG. 5 is a block diagram of a pre-trained deep learning model 500. In examples, the model 500 infrastructure is feasible for cloud-deployment. Image pairs 100 are obtained as input to a pre-trained deep leaning model selected at block 502. Generally, a pre-trained deep learning model is previously trained to make predictions. In the examples provided herein, the pre-trained deep learning models are previously trained image classification models. In some embodiments, the selected pre-trained deep learning model at block 502 is any one of EfficientNet, MobileNet, Inception V3, ResNet and the like. In some embodiments, the pre-trained deep learning model selected at block 502 is a best model that yields a highest accuracy in predicting a classification of a particular symbology. The most accurate pre-trained model is selected as a base-model.

At block 504, the base model is customized. In particular, weights of the selected pre-trained deep learning model are updated in a controlled, predetermined manner. Layers of the pre-trained deep learning model are iteratively frozen during further training. By freezing layers during training, computational time used for training is reduced with a minimal loss in accuracy of the resulting trained model. In examples, customization includes a combination of freezing and unfreezing layers in the base-model and adding custom convolutional blocks and dense layers to the base model. The customized pre-trained model is then used to predict a classification of the images as genuine or photocopy/counterfeit at block 506. A confusion matrix at block 508 is used to evaluate the effectiveness of the customized pre-trained model used to predict classifications at block 506.

FIG. 6 is a block diagram of a pre-trained lite deep learning model 600. In examples, the model 600 infrastructure is feasible for mobile/edge-deployment. Image pairs are obtained as input to pre-trained deep leaning model selected at block 602. Similar to the pre-trained model 500 of FIG. 5, the selected pre-trained deep learning model at block 602 is any one of EfficientNet, MobileNet, Inception V3, is ResNet and the like. In some embodiments, the pre-trained deep learning model selected at block 602 is a best model that yields a highest accuracy in predicting a classification of a particular symbology.

The base model is customized at block 604 by freezing and unfreezing layers in the base-model and adding custom convolutional blocks and dense layers. At block 606, the customized pre-trained model is converted to a pre-trained lite deep learning model. In some embodiments, conversion to a lite model facilitates mobile or edge deployment (e.g., execution of the model using mobile platforms or operating systems including iOS, Android, and the like). In examples, the pre-trained models are hosted by a cloud-based infrastructure.

At block 608, quantization is applied to the pre-trained lite deep learning model to enable mobile deployment and integration with current mobile device applications. Quantization reduces the model size without compromising an accuracy of predictions made by the model. Generally, quantization generates an approximation of a machine learning model by representing floating-point numbers with numbers using a lower bit-length. The approximation of the model reduces the memory used to store the model as well as computational resources consumed during the execution of the model.

Quantization can be performed according to one or more quantization techniques. For example, quantization includes but is not limited to, dynamic range quantization, full integer quantization, float16 quantization, or any combinations thereof. Generally, dynamic range quantization quantizes weights of a trained model based on the dynamic range of the weights of the trained model. In examples, dynamic range quantization transforms weights of the trained model from a floating point numerical representation to an integer numerical representation. Floating point numerical representations can occupy 32-bits of memory, while integer numerical representations occupy 8-bits of memory. Accordingly, dynamic range quantization creates a model with reduced memory use when compared to the original model. Similarly, full integer quantization enables reductions in memory use by quantizing all weights and activation outputs of the trained model to integer numerical representations, each 8-bits in size. In some embodiments, a range (e.g., minimum and maximum) of all floating-point tensors of the trained model are estimated to determine is the quantizations of the weights and activation outputs during full integer quantization.

Float16 quantization reduces the size of a trained model that includes floating-point numerical representations by quantizing the weights to float16. Generally, float16 is a 16-bit floating point representation according to the “IEEE Standard for Floating-Point Arithmetic,” in IEEE Std 754-2019 (Revision of IEEE 754-2008) , vol., no., pp.1-84, 22 Jul. 2019, doi: 10.1109/IEEESTD.2019.8766229. Float16 quantization reduces a size of the pre-trained model by up to half by reducing weights of the pre-trained model by half of their original size.

Table 2 provides a summary of an accuracy associated with trained models 300, 400, 500, and 600. For each model, input images were provided of marks that include photocopies and genuine marks. Each model demonstrated accurate classification at nearly 100% of genuine or photocopy on unseen images. In Table 2, the macro-average is mean of genuine and photocopy accuracies. This is a metric to represent model accuracies across 2 classes (genuine and photocopy class). Training time, in seconds provides a duration of time for training each model.

| | Photo-Copy | Genuine | Macro- | Model | | Training | Feature ext-. and |
|---|---|---|---|---|---|---|---|
| Model type | Accuracies | Accuracies | Average | Size | | Time (s) | Inference Time (s) |
| Haralick-Xgboost | 99.78% | 100% | 99.9% | 0.8 | MB | 2569 | 0.08 sec. |
| GLCM-CNN | 99.93% | 100% | 100.0% | 49 | MB | 4303 | 0.03 sec. |
| Pre-trained DL | 100.00% | 100% | 100.0% | 129 | MB | 30414 | 0.04 sec. |
| Pre-trained DL-Lite | 100.00% | 100% | 100.0% | 12.9 | MB | 5630 | 0.45 sec. |

The quantized pre-trained deep learning model is then used to predict a classification of the images as genuine or photocopy/counterfeit at block 610. A confusion matrix at block 612 is used to evaluate the effectiveness of the quantized pre-trained deep learning model used to predict classifications at block 612.

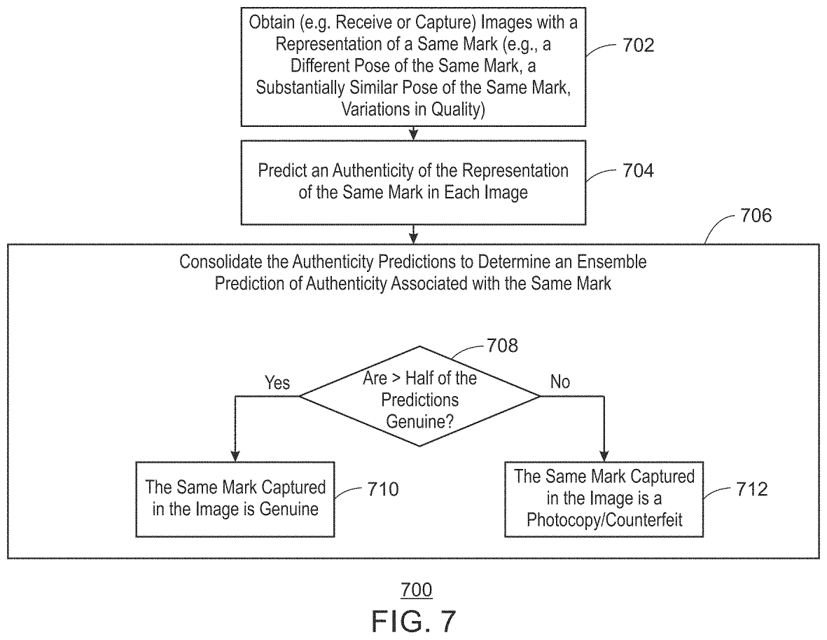

FIG. 7 illustrates a process 700 for photocopy or counterfeit detection in symbologies. At block 702, images are received from an image capture device with a representation of a same mark. As discussed above, the mark is a visual, machine-readable portion of a symbology. In some embodiments, the mark is a one-dimensional or two-dimensional code such as a QR-code or barcode. The mark is created through various printing processes, such as laser print, inkjet, thermal printing, and the like. Each image of the images 702 captures at least a portion of the mark.

At block 704, an authenticity of the representation of the same mark in each image is predicted to obtain an authenticity prediction corresponding to each image of is the set of images. The authenticity prediction of the representation of the same mark refers to the mark being classified as a genuine mark or a photocopy/counterfeit mark. A classification of genuine or photocopy/counterfeit is predicted for each image. The classifications are determined by the model 300 of FIG. 3, model 400 of FIG. 4, model 500 of FIG. 5, model 600 of FIG. 6, or any combinations thereof.

At block 706, the authenticity predictions are consolidated to determine an ensemble prediction of authenticity associated with the same mark. In some embodiments, a mode of authenticity predictions associated with the multiple images is calculated to determine the ensemble prediction. If an equal number of images have authenticity predictions of genuine and photocopy/counterfeit, then the mark is predicted to be a photocopy/counterfeit. The ensemble prediction of authenticity is genuine when a predetermined number of authenticity predictions indicate the same mark is genuine. The ensemble prediction of authenticity is photocopy/counterfeit when a predetermined number of authenticity predictions indicate the same mark is a photocopy/counterfeit. In examples, the predetermined number of authenticity predictions is half of the authenticity predictions output by a model.

In some embodiments, each of the model 300 of FIG. 3, model 400 of FIG. 4, model 500 of FIG. 5, model 600 of FIG. 6, or any combinations thereof (collectively referred to as the “models”), output respective authenticity predictions of a same mark. The authenticity predictions output by the models are consolidated further by taking a vote. In examples, the ensemble prediction of authenticity is a 2-layer approach, with a first layer of authenticity predictions of a same mark output by multiple models. The first layer of authenticity predictions is based on multiple images from one or more of the models. The second layer consolidates the authenticity predictions output by the one or more models from the first layer, and outputs an ensemble prediction of authenticity associated with the same mark. In some embodiments, the models selected to output authenticity predictions are configured for cloud-deployment.

In some embodiments, the authenticity predictions from the models are consolidated to determine an ensemble prediction of authenticity associated with the same mark. The authenticity predictions from the models may be consolidated according to weighted voting, where predictions from the models are differently weighted to calculate an ensemble prediction. In examples, a weight of 1.5 is applied is to an authenticity prediction output by model 300, while a weight of 1 is applied to the authenticity prediction from other model(s). In some embodiments, weights are assigned to the authenticity predictions output by the one or more models based on a respective prior performance of the model or by a user.

The authenticity predictions from the models may also be consolidated according to score averaging. In score averaging, the models output an authenticity prediction that is a likelihood or probability of the same mark being genuine or photocopy/counterfeit. The likelihood or probability is use to generate a score. In an example, a score of one indicates an authenticity prediction of genuine, and a score of zero indicates an authenticity prediction of photocopy/counterfeit. The scores output by the models are averaged, and an ensemble prediction of authenticity is based on the average score. A predetermined threshold is applied to the average score. For example, if the average is greater than a predetermined threshold of 0.5, the ensemble prediction of authenticity is genuine. The authenticity predictions from the models may be consolidated according to weighted score averaging. In weighted score averaging, a differential weight is applied to the score from each model, such as the scores obtained according to score averaging.

In some embodiments, a set of metrics associated are calculated for a mark with an authenticity prediction of genuine. To calculate the set of metrics, the mark is divided into a grid of cells, each cell representing a portion of the mark. In examples, the metrics include, for example, a deviation in average cell pigmentation or marking intensity, a cell position bias relative to a best-fit grid, the presence or location of extraneous marks or voids in the mark, and the shape (linearity) of long continuous edges of the mark. An electronic signature is generated based on the set of metrics for the genuine mark. The electronic signature is generated in parallel with consolidating the authenticity predictions to determine the ensemble prediction of authenticity associated with the same mark.

FIG. 8 is a block diagram of a system 800 that enables photocopy or counterfeit detection in symbologies. In examples, the system 800 includes, among other equipment, a controller 802. Generally, the controller 802 is small in size and operates with lower processing power, memory and storage when compared to other processors such as GPUs or CPUs. In some embodiments, the controller 802 consumes very little energy and is efficient. In examples, the controller 802 is a component of (or is) a mobile device, such as a cellular phone, tablet, and the like. In some cases, the controller 802 is operable using battery power and is not required to be connected to mains power.

The controller 802 includes a processor 804. The processor 804 can be a microprocessor, a multi-core processor, a multithreaded processor, an ultra-low-voltage processor, an embedded processor, or a virtual processor. In some embodiments, the processor 804 can be part of a system-on-a-chip (SoC) in which the processor 804 and the other components of the controller 802 are formed into a single integrated electronics package.

The processor 804 can communicate with other components of the controller 802 over a bus 806. The bus 806 can include any number of technologies, such as industry standard architecture (ISA), extended ISA (EISA), peripheral component interconnect (PCI), peripheral component interconnect extended (PCIx), PCI express (PCIe), or any number of other technologies. The bus 806 can be a proprietary bus, for example, used in an SoC based system. Other bus technologies can be used, in addition to, or instead of, the technologies above.

The bus 806 can couple the processor 808 to a memory 808. In some embodiments, such as in PLCs and other process control units, the memory 808 is integrated with a data storage 810 used for long-term storage of programs and data. The memory 808 can include any number of volatile and nonvolatile memory devices, such as volatile random-access memory (RAM), static random-access memory (SRAM), flash memory, and the like. In smaller devices, such as programmable logic controllers, the memory 808 can include registers associated with the processor itself The storage 810 is used for the persistent storage of information, such as data, applications, operating systems, and so forth. The storage 810 can be a nonvolatile RAM, a solid-state disk drive, or a flash drive, among others. In some embodiments, the storage 810 will include a hard disk drive, such as a micro hard disk drive, a regular hard disk drive, or an array of hard disk drives, for example, associated with a distributed computing system or a cloud server.

The bus 810 couples the processor 808 to an input/output interface 812. The input/output interface 812 connects the controller 802 to the input/output devices 814. In some embodiments, the input/output devices 814 include printers, displays, touch screen displays, keyboards, mice, pointing devices, and the like. In some examples, one or more of the I/O devices 814 can be integrated with the controller 802 into a computer, such as a mobile computing device, e.g., a smartphone or tablet computer. The controller 802 also includes an image capture device 816. Generally, the image capture device 816 includes hardware associated with image capture. The image capture device can be, for example, a camera or scanner. In some embodiments, the image capture device 816 automatically captures a representation of a mark. In some embodiments, the image capture device 816 captures a representation of a mark in response to input from a user at an input/output device 814.

The controller 802 also includes machine learning models 818. The machine learning models 818 can be, for example, the model 300 of FIG. 3, the model 400 of FIG. 4, the model 500 of FIG. 5, the model 600 of FIG. 6, or any combinations thereof. In some embodiments, the machine learning models are trained and output authenticity predictions as described in connection with process 700 of FIG. 7. Additionally, the controller 802 includes a network interface 820. The network interface 820 enables the controller 802 to transmit and receive information across a network 822. Although not shown in the interests of simplicity, several similar controllers 802 can be connected to the network 822. In some embodiments, multiple controllers 802 include trained machine learning models 818 communicatively coupled with a server computer 824. In some embodiments, the server computer 824 obtains images and corresponding predictions from one or more controllers 802 and aggregates the obtained information to continually update (e.g., modify weights associated with) the machine learning models distributed across the one or more controllers 802. In this manner, the present techniques enable continuous learning by the machine learning models using newly obtained data.

In some embodiments, a signature generator 826 measures a set of metrics associated with a characteristic of a genuine mark and generates an electronic signature based on the set of metrics for the genuine mark, wherein the electronic signature is generated in parallel with consolidating the authenticity predictions to determine the ensemble prediction of authenticity associated with the same mark. In some examples, the electronic signature is generated in parallel with consolidating (e.g., consolidator 206 of FIG. 2) the authenticity predictions output by the model 300 of FIG. 3, the model 400 of FIG. 4, the model 500 of FIG. 5, the model 600 of FIG. 6, or any combinations thereof.

In the example of FIG. 8, an ensemble prediction of authenticity is provided as feedback to and/or a backup check 828 of the electronic signature generator 826 based on the same mark. The ensemble prediction of authenticity can be a backup check 828 for a fingerprinting process performed by the signature generator 826. Moreover, the ensemble prediction of authenticity can be a feedback signal 828 into the fingerprinting process performed by the signature generator 826, where the feedback signal 828 is used to improve the fingerprinting process. Finally, it should be noted that the fingerprinting process performed by the signature generator 826 and the machine learning process performed using one or more machine learning models 818 need not be implemented in the same one or more computers 802, 824. In some implementations, they are implemented on one or more separate computers 802, 824, and communicate with each other over the network 822.

Other implementations are also within the scope of the following claims.

What is claimed is:

1. A method, comprising:
obtaining, using a processing device, images with a representation of a same mark;
predicting, using the processing device, an authenticity of the representation of the same mark in each image to obtain an authenticity prediction corresponding to each image of the set of images; and
consolidating, using the processing device, the authenticity predictions to determine an ensemble prediction of authenticity associated with the same mark.

2. The method of claim 1, wherein the ensemble prediction of authenticity is genuine when more than half of the authenticity predictions indicate the same mark is genuine.

3. The method of claim 1, further comprising:
measuring a set of metrics associated with a characteristic of a genuine mark; and
generating an electronic signature based on the set of metrics for the genuine mark, wherein the electronic signature is generated in parallel with consolidating the authenticity predictions to determine the ensemble prediction of authenticity associated with the same mark.

4. The method of claim 1, wherein an image of the images is a different pose of the same mark.

5. The method of claim 1, wherein the images comprise a substantially similar pose of the same mark.

6. The method of claim 1, wherein the images vary in quality.

7. The method of claim 1, wherein predicting an authenticity of the representation of the same mark in each image to obtain an authenticity prediction comprises:
extracting texture features of the images;
inputting the texture features to a gradient boosted decision tree classifier; and
outputting the authenticity predictions.

8. The method of claim 1, wherein predicting an authenticity of the representation of the same mark in each image to obtain an authenticity prediction comprises:
converting the images to gray level co-occurrence matrices (GLCMs);
extracting GLCM features from the GLCM matrices;
inputting the GLCM features to a convolutional neural network classifier; and
outputting the authenticity predictions.

9. The method of claim 1, wherein predicting an authenticity of the representation of the same mark in each image to obtain an authenticity prediction comprises:
selecting a pre-trained deep learning model;
customizing at least one layer of the pre-trained deep learning model;
inputting the images to the customized, pre-trained deep learning model; and
outputting, by the pre-trained deep learning model, the authenticity predictions.

10. The method of claim 1, wherein predicting an authenticity of the representation of the same mark in each image to obtain an authenticity prediction comprises:
selecting a pre-trained deep learning model;
customizing at least one layer of the pre-trained deep learning model;
quantizing the customized, pre-trained deep learning model;
inputting the images to the quantized, customized, pre-trained deep learning model; and
outputting, by the quantized, customized pre-trained deep learning model, the authenticity predictions.

11. The method of claim 1, wherein the processing device is a mobile device, the obtaining comprises receiving the images in response to a user initiating image capture at the mobile device and the receiving, predicting, and consolidating are performed by the mobile device.

12. The method of claim 1, the predicting an authenticity of the representation of the same mark in each image to obtain an authenticity prediction comprises obtaining respective authenticity predictions from multiple models and consolidating the respective authenticity predictions from the multiple models.

13. A system, comprising:
at least one processor, and
at least one non-transitory storage media storing instructions that, when executed by the at least one processor, cause the at least one processor to:
obtain images with a representation of a same mark;
predict an authenticity of the representation of the same mark in each image to obtain an authenticity prediction corresponding to each image of the set of images; and
consolidate the authenticity predictions to determine an ensemble prediction of authenticity associated with the same mark.

14. The system of claim 13, wherein the ensemble prediction of authenticity is genuine when more than half of the authenticity predictions indicate the same mark is genuine.

15. The system of claim 13, wherein the instructions cause the processor to:
measuring a set of metrics associated with a characteristic of a genuine mark; and
performing the electronic signature generation based on the set of metrics for the genuine mark, wherein an electronic signature is generated in parallel with consolidating the authenticity predictions to determine the ensemble prediction of authenticity associated with the same mark;
providing the ensemble prediction of authenticity as feedback to the electronic signature generation based on the same mark, wherein the ensemble prediction of authenticity is a backup check for a fingerprinting process.

16. The system of claim 13, wherein the processing device is a mobile device, the obtaining comprises receiving the images in response to a user initiating image capture at the mobile device and the receiving, predicting, and consolidating are performed by the mobile device.

17. At least one non-transitory storage media storing instructions that, when executed by at least one processor, cause the at least one processor to:
obtain images with a representation of a same mark;
predict an authenticity of the representation of the same mark in each image to obtain an authenticity prediction corresponding to each image of the set of images; and
consolidate the authenticity predictions to determine an ensemble prediction of authenticity associated with the same mark.

18. The at least one non-transitory storage media of claim 17, wherein the ensemble prediction of authenticity is genuine when more than half of the authenticity predictions indicate the same mark is genuine.

19. The at least one non-transitory storage media of claim 17, further comprising:
measuring a set of metrics associated with a characteristic of a genuine mark; and
generating an electronic signature based on the set of metrics for the genuine mark, wherein the electronic signature is generated in parallel with consolidating the authenticity predictions to determine the ensemble prediction of authenticity associated with the same mark.

20. The at least one non-transitory storage media of claim 17, wherein the processing device is a mobile device, the obtaining comprises receiving the images in response to a user initiating image capture at the mobile device and the receiving, predicting, and consolidating are performed by the mobile device.
